(19) United States
(12) Patent Application Publication
(10) Pub. No.: US 2024/0178436 A1
(43) Pub. Date: May 30, 2024

(54) BATTERY CELL PRESSING DEVICE

(71) Applicant: SK On Co., Ltd., Seoul (KR)

(72) Inventors: Kyu Beom KIM, Daejeon (KR); Chae Rin RYOU, Daejeon (KR); Hyeon Su BAE, Daejeon (KR); Ye Jin YUN, Daejeon (KR); Jeong Hyeon YUN, Daejeon (KR); Hyea Won YUN, Daejeon (KR); Ji Hyeon LEE, Daejeon (KR); Jong Chan IM, Daejeon (KR)

(21) Appl. No.: 18/486,157

(22) Filed: Oct. 13, 2023

(30) Foreign Application Priority Data
Nov. 30, 2022 (KR) 10-2022-0164737

(51) Int. Cl. H01M 10/04; H01M 10/0585

(52) U.S. Cl. CPC H01M 10/0468; H01M 10/0404; H01M 10/0585

(57) ABSTRACT

To improve pressure measurement reliability and safety of a battery cell and finely control pressure, the disclosure of the present application provides a battery cell pressing device comprising: a battery cell; a plurality of upper plates disposed above the battery cell; a plurality of lower plates disposed below the battery cell; a first pressing member interposed between the plurality of upper plates; and a second pressing member interposed between the plurality of lower plates, wherein a magnetic force is generated at the first pressing member and the second pressing member by an applied current.

### CROSS-REFERENCE TO RELATED PATENT APPLICATION

The present application claims priority under 35 U.S.C. § 119(a) to Korean patent application number 10-2022-0164737 filed on Nov. 30, 2022, in the Korean Intellectual Property Office, the entire disclosure of which is incorporated by reference herein.

### BACKGROUND OF THE INVENTION

### 1. Field

The present disclosure relates to a battery cell pressing device.

### 2. Description of the Related Art

As the electronics, communications, and space industries develop, demand for lithium secondary batteries as an energy power source is drastically increasing. In particular, as the importance of global eco-friendly policies is emphasized, the electric vehicle market is growing swiftly, and research and development on lithium secondary batteries are being actively conducted worldwide.

Among various secondary batteries, research and development on lithium secondary batteries having a high discharge voltage and energy density is being most actively conducted. An electrode assembly, which is a unit cell of lithium secondary batteries, may be manufactured by a process in which a separator is interposed between a cathode and an anode and stacked, and then each of a plurality of cathodes and each of a plurality of anodes are combined as one and welded together to supply current to each electrode.

One of the technical challenges of lithium secondary batteries is to improve safety. Lithium secondary batteries have a problem that safety is threatened by internal short-circuit caused by external impact, heat generation by overcharging, overdischarging and the like, and electrolyte decomposition and thermal runaway due to heat generation.

In particular, an increase of internal pressure of lithium secondary batteries due to electrolyte decomposition may cause an explosion. To solve such a safety problem of lithium secondary batteries, it is required to measure an internal pressure during charging and discharging of secondary batteries and to manufacture a secondary battery exterior case that is capable of tolerating the measured internal pressure.

FIG. 1 is a schematic plan diagram of a conventional battery cell pressing device. Referring to FIG. 1, a battery cell pressing device 1 has a structure for measuring an internal pressure of a battery cell 2 by using a spring 3 and a fastening member 4. However, due to a structural constraint that even when a spring 3 and a fastening member 4 are used, a high pressure A is applied to one part of a battery cell 2 and a low pressure B is applied to another part of a battery cell 2, and thus it is difficult to apply a constant pressure to all surfaces of a battery cell 2, resulting in a decrease of the reliability of pressure measurement of a battery cell 2. In addition, since a battery cell pressing device 1 controls pressure by using a pre-fastened spring 3 and a fastening member 4, there was a problem that pressure of a battery cell pressing device 1 could not be controlled during pressure measurement of a battery cell 2.

As described above, there is a need for a technology capable of accurately measuring an internal pressure of a battery cell and controlling pressure during pressure measurement of a battery cell.

### SUMMARY OF THE INVENTION

The present disclosure provides a battery cell pressing device capable of improving pressure measurement reliability and safety of a battery cell and finely controlling pressure during pressure measurement of a battery cell.

In addition, the present disclosure can be widely applied in green technology fields such as Electric Vehicle, battery charging station, solar power generation using other batteries, and wind power generation.

In addition, the present disclosure can be used for eco-friendly electric vehicles, hybrid vehicles, and the like to prevent climate emissions.

A battery cell pressing device according to the present disclosure comprises a battery cell; a plurality of upper plates disposed above the battery cell; a plurality of lower plates disposed below the battery cell; a first pressing member interposed between the plurality of upper plates; and a second pressing member interposed between the plurality of lower plates, wherein a magnetic force is generated at the first pressing member and the second pressing member by an applied current.

In one embodiment of the present disclosure, the upper plate may comprise a first upper plate in contact with an upper portion of the battery cell and a second upper plate spaced apart from the first upper plate in parallel.

In one embodiment of the present disclosure, the first pressing member may be interposed between the first upper plate and the second upper plate.

In one embodiment of the present disclosure, the lower plate may comprise a first lower plate in contact with a lower portion of the battery cell and a second lower plate spaced apart from the first lower plate in parallel.

In one embodiment of the present disclosure, the second pressing member may be interposed between the first lower plate and the second lower plate.

In one embodiment of the present disclosure, each of the plurality of upper plates and the plurality of lower plates may be spaced apart in parallel.

In one embodiment of the present disclosure, an attractive force may be generated between the first pressing member and the second pressing member by the magnetic force.

In one embodiment of the present disclosure, the battery cell may be pressurized by the attractive force.

In one embodiment of the present disclosure, the first pressing member and the second pressing member may have a coil shape.

In one embodiment of the present disclosure, the first pressing member and the second pressing member may be plural.

In one embodiment of the present disclosure, the plurality of first pressing members and the plurality of second pressing members may be the same in number and may be disposed at positions corresponding to each other.

In one embodiment of the present disclosure, four of the first pressing members may be provided to be interposed in vertex areas of the plurality of upper plates, and four of the second pressing members may be provided to be interposed in vertex areas of the plurality of lower plates.

In one embodiment of the present disclosure, the current may be applied such that a magnetic force may be formed in the same direction at the plurality of first pressing members.

In one embodiment of the present disclosure, the current may be applied such that a magnetic force may be formed in the same direction at the plurality of second pressing members.

In one embodiment of the present disclosure, the magnetic force at the first pressing member and the second pressing member may be controlled by intensity of the current.

In one embodiment of the present disclosure, the pressing device may further comprise a pressure sensor.

In one embodiment of the present disclosure, the pressure sensor may measure pressure according to swelling during charging and discharging of the battery cell.

In one embodiment of the present disclosure, the pressing device may comprise a base plate capable of transmitting pressure of the battery cell to the pressure sensor.

In one embodiment of the present disclosure, the pressure sensor may be interposed between the base plate and the lower plate.

In one embodiment of the present disclosure, the pressing device may comprise a fastening means penetrating the plurality of upper plates, the plurality of lower plates, and the first pressing member and the second pressing member.

In one embodiment of the present disclosure, the fastening means may comprise a stopper member limiting separation of the upper plate.

A pressing device according to the present disclosure comprise first pressing member and second pressing member at which a magnetic force is formed by an applied current, so that a same and constant pressure can be applied to all surfaces of a battery cell to improve pressure measurement reliability of a battery cell.

In addition, a pressing device according to the present disclosure has an effect of finely controlling pressure by varying a magnetic force by changing the value of a current applied during pressure measurement of a battery cell.

In addition, a pressure device according to the present disclosure comprises a fastening means penetrating a first pressing member, a second pressing member, and a plate, so that safety of pressure measurement of a battery cell can be improved.

### BRIEF DESCRIPTION OF THE DRAWINGS

FIG. 1 is a schematic plan diagram of a conventional battery cell pressing device.

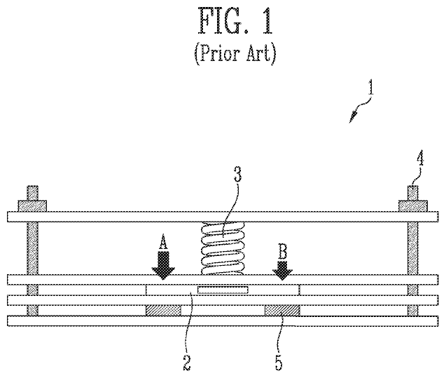

FIG. 2 is a schematic perspective diagram of a battery cell pressing device according to an embodiment of the present disclosure.

FIG. 3 is a schematic plan diagram of a pressing device in which an attractive force is generated between a first pressing member and a second pressing member by application of a current.

FIG. 4 is a schematic plan diagram of a pressing device comprising a pressure sensor.

FIG. 5 is a schematic plan diagram of a pressing device comprising a fastening means and a stopper member.

### DETAILED DESCRIPTION

The structural or functional descriptions of embodiments disclosed in the present specification or application are merely illustrated for the purpose of explaining embodiments according to the technical principle of the present disclosure, and embodiments according to the technical principle of the present disclosure may be implemented in various forms in addition to the embodiments disclosed in the specification of application. In addition, the technical principle of the present disclosure is not construed as being limited to the embodiments described in the present specification or application.

Hereinafter, a battery cell pressing device according to the present disclosure will be described in detail.

A battery cell pressing device according to the present disclosure comprises a battery cell; a plurality of upper plates disposed above the battery cell; a plurality of lower plates disposed below the battery cell; a first pressing member interposed between the plurality of upper plates; and a second pressing member interposed between the plurality of lower plates, wherein a magnetic force is generated at the first pressing member and the second pressing member by an applied current.

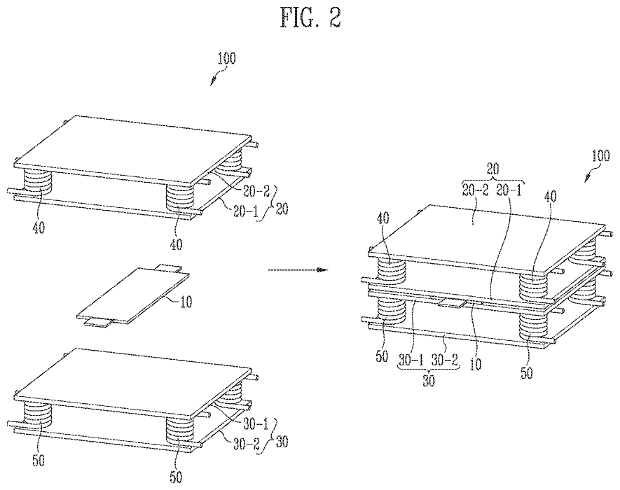

FIG. 2 is a schematic perspective diagram of a battery cell pressing device according to an embodiment of the present disclosure.

Referring to FIG. 2, a battery cell pressing device 100 according to the present disclosure comprises a battery cell 10. The battery cell 10 may comprise an electrode assembly and a case accommodating an electrode assembly.

An electrode assembly may comprised a stacked structure of a cathode, an anode, and a separator interposed between a cathode and an anode. A cathode may comprise a cathode active material, and an anode may comprise an anode active material which lithium (Li) ions generated from a cathode active material may be inserted to and extracted from. In addition, a cathode and an anode may further comprise a binder and a conductive material in a cathode active material and an anode active material, respectively, to improve mechanical safety and electrical conductivity. A separator may be configured to prevent an electrical short circuit a cathode and an anode and to generate a flow of ions. The type of separator is not particularly limited, but may comprise a porous polymer film. An electrode assembly may be manufactured by stacking or zigzag stacking by alternately stacking a plurality of cathodes and anodes and interposing a separator between cathodes and anodes.

A case may be a pouch made of a flexible material. A case may comprise a lower sheet on which a cup portion for accommodating an electrode assembly is formed and an upper sheet covering a lower sheet. A cup portion may prevent an electrode assembly from being separated from a case. A lower sheet and an upper sheet may protect an electrode assembly from external environment. A lower sheet and an upper sheet may comprise a water-resistant resin, and may be in the form of a film in which, for example, a polyolefin-based resin, a metal, a nylon resin, and a polyterephthalate resin are stacked.

A battery cell 10 may further comprise an electrolyte solution. An electrolyte may be a non-aqueous electrolyte. An electrolyte may comprise a lithium salt and an organic solvent. For example, an organic solvent may comprise at least one selected from the group consisting of propylene carbonate (PC), ethylene carbonate (EC), diethyl carbonate (DEC), dimethyl carbonate (DMC), ethyl methyl carbonate (EMC), methyl propyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

A battery cell pressing device 100 comprises a plurality of upper plates 20 disposed above a battery cell 10 and a plurality of lower plates 30 disposed below a battery cell 10. The position of an upper plate 20 may be fixed in a vertical direction. The position of an upper plate 20 may be constantly maintained even when swelling occurs in a battery cell 10 according to charging and discharging of a battery cell 10. As the position of an upper plate 20 is fixed, a battery cell pressing device 100 may limit upward expansion of a battery cell 10. A lower plate 30 may be spaced apart from an upper plate 20 by a predetermined distance to form a space in which a battery cell 10 may be accommodated between a lower plate 30 and an upper plate 20. A battery cell 10 may be seated between an upper plate 20 and a lower plate 30 in a flattened form such that a wide surface of a battery cell may face an upper direction and a lower direction.

An upper plate 20 may comprise a first upper plate 20-1 in contact with an upper portion of a battery cell 10 and a second upper plate 20-2 spaced apart from a first upper plate 20-1 in parallel. A lower plate 30 may comprise a first lower plate 30-1 in contact with a lower portion of a battery cell 10 and a second lower plate 30-2 spaced apart from a first lower plate 30-1 in parallel. Each of the plurality of upper plates 20-1, 20-2 and the plurality of lower plates 30-1, 30-2 may be spaced apart in parallel. As a first upper plate 20-1 and a first lower plate 30-1 are spaced apart in parallel, a battery cell 10 may be seated in a flattened form in a holding space between a first upper plate 20-1 and a first lower plate 30-1. Therefore, a same and constant pressure can be applied to all surfaces of a battery cell 10 to improve pressure measurement reliability of a battery cell 10.

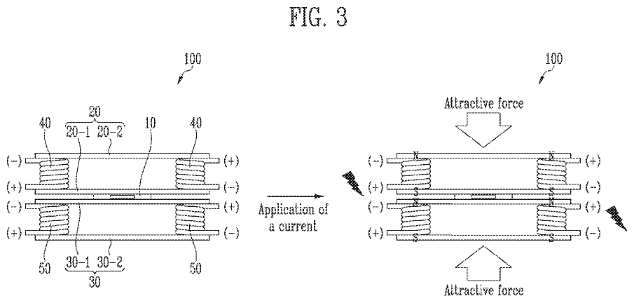

FIG. 3 is a schematic plan diagram of a pressing device in which an attractive force is generated between a first pressing member and a second pressing member by application of a current.

Referring to FIG. 3, a battery cell pressing device 100 comprises a first pressing member 40 interposed between a plurality of upper plates 20 and a second pressing member 50 interposed between a plurality of lower plates 30. A first pressing member 40 may be interposed between a first upper plate 20-1 and a second upper plate 20-2, and a second pressing member 50 may be interposed between a first lower plate 30-1 and a second lower plate 30-2. A battery cell 10 may be pressurized by a first pressing member 40 and a second pressing member 50.

A magnetic force is generated at a first pressing member 40 and a second pressing member 50 by an applied current. Due to this magnetic force, an attractive force may be generated between a first pressing member 40 and a second pressing member 50, and a battery cell pressing device 100 may pressurize a battery cell 10 by an attractive force between a first pressing member 40 and a second pressing member 50.

Specifically, a first pressing member 40 and a second pressing member 50 may be plural, and a plurality of first pressing members 40 and a plurality of second pressing members 50 may be the same in number and may be disposed at positions corresponding to each other. Four first pressing members 40 may be provided to be interposed in vertex regions of a plurality of upper plates 20-1, 20-2, and four second pressing members 50 may be provided to be interposed in vertex regions of a plurality of lower plates 30-1, 30-2.

A first pressing member 40 and a second pressing member 50 may be a coil-shaped member capable of conducting a current, and may receive a current from a power supply device (not shown) so that an attractive force may be generated by an induced magnetic field. A magnetic force may be generated in a first direction or in a second direction opposite to a first direction according to electromagnetic induction by a current and Ampere's right hand rule (Ampere's law).

A current may be applied so that a magnetic force of a same direction may be formed at a plurality of first pressing members 40. In addition, a current may be applied so that a magnetic force of a same direction may be formed at a plurality of second pressing members 50.

For example, at each of a plurality of first pressing members 40 and a plurality of second pressing members 50, the direction of a magnetic force may be determined according a coil winding direction or a direction in which a current is applied to a coil. Accordingly, a coil winding direction or a direction in which a current is applied to a coil may be set so that an attractive force may be formed each between a plurality of first pressing members 40 and a plurality of second pressing members 50.

FIG. 3 illustrates a coil winding direction or a current application direction such that an S pole is generated at a position relatively close to a first upper plate 20-1 in a first pressing member 40, and an N pole is generated at a position relatively close to a first lower plate 30-1 in a second pressing member 50. As such, as an S pole is generated at a position close to a first upper plate 20-1 and an N pole is generated at a position close to a first lower plate 30-1, an attractive force may be transmitted between a first upper plate 20-1 and a first lower plate 20-1 to pressurized a battery cell. 10.

Meanwhile, FIG. 3 illustrates that an S pole is generated at a position close to a first upper plate 20-1 and an N pole is generated at a position close to a first lower plate 30-1, but it may be set according to the need that an N pole is generated at a position close to a first upper plate 20-1 and an S pole is generated at a position close to a first lower plate 30-1.

A magnetic force at a first pressing member 40 and a second pressing member 50 may be controlled by intensity of an applied current. In addition, when a current of a same intensity is applied to a first pressing member 40 and a second pressing member 50, a magnetic force of a same intensity may be formed at a first pressing member 40 and a second pressing member 50 so that a same and constant pressure can be applied to all surfaces of a battery cell 10. Therefore, reliability of pressure measurement of a battery cell 10 can be improved. In addition, by varying a magnetic force by changing the value of a current applied to a first pressing member 40 and a second pressing member 50 during pressure measurement of a battery cell 10, there is an effect of finely controlling the pressure applied to a battery cell 10 from a first pressing member 40 and a second pressing member 50.

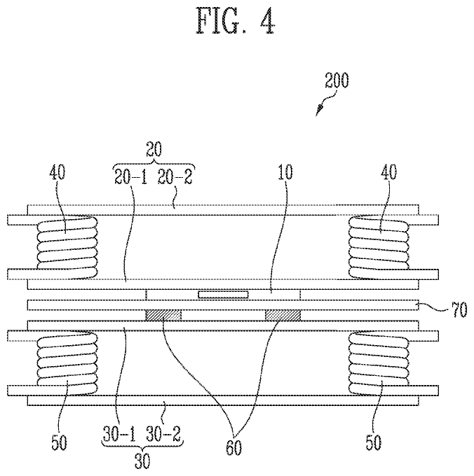

FIG. 4 is a schematic plan diagram of a pressing device comprising a pressure sensor.

Referring to FIG. 4, a battery cell pressing device 200 may further comprise a pressure sensor 60. A battery cell pressing device 200 may comprise a base plate 70 capable of transmitting pressure of a battery cell 10 to a pressure sensor 60. A pressure sensor 60 may be interposed between a base plate 70 and a lower plate 30.

A base plate 70 may be formed parallel to a upper plate 20 and a lower plate 30. In addition, a base plate 70 may be formed to horizontally support a battery cell 10 at a bottom of a battery cell 10, and a base plate 70 may have an area larger than a bottom area of a battery cell 10 to safely support a bottom surface of a battery cell 10. A base plate 70 may be made of a metal, a metal alloy, a reinforced plastic having excellent rigidity, a reinforced ceramic, a carbon steel, and the like to sufficiently tolerate a swelling pressure of a battery cell 10.

A pressure sensor 60 may measure pressure according to swelling during charging and discharging of a battery cell 10. Specifically, when a battery cell 10 expands due to a gas generated internally during charging and discharging of a battery cell 10, a pressure sensor 60 may measure the magnitude of pressure caused by expansion of a battery cell 10. By measuring a pressure during charging and discharging of a battery cell 10, a case of a battery cell 10 that can tolerate a measured pressure can be designed, and the problem that safety is threatened by a pressure increase of a battery cell 10 may be minimized.

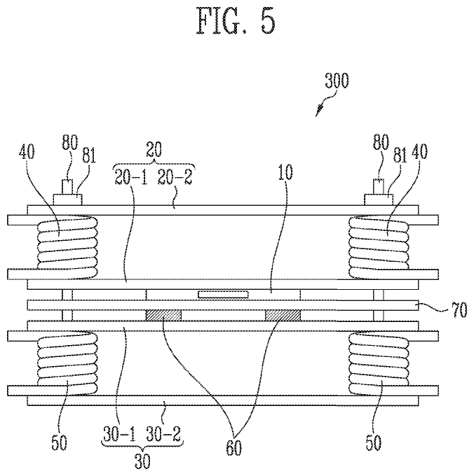

FIG. 5 is a schematic plan diagram of a pressing device comprising a fastening means and a stopper member.

Referring to FIG. 5, a battery cell pressing device 300 may comprise a fastening means 80 penetrating a plurality of upper plates 20, a plurality of lower plates 30, and a first pressing member and a second pressing member 40, 50. A fastening means 80 may comprise a stopper member 81 limiting separation of an upper plate 20. A fastening means 80 may protrude to an upper end of a second upper plate 20-2, and a stopper member 81 may be fastened to a protruding portion. In addition, a thread may be formed on a protruding portion of a fastening means 80, and a stopper member 81 having a nut shape may be fastened to a thread. A fastening means 80 and a stopper member 81 may fix an upper plate not to move upward even when an upper plate 20 is pressurized by swelling during charging and discharging of a battery cell 10. Therefore, safety of pressure measurement of a battery cell 10 may be improved.

What is claimed is:

1. A battery cell pressing device comprising:
a battery cell;
a plurality of upper plates disposed above the battery cell;
a plurality of lower plates disposed below the battery cell;
a first pressing member interposed between the plurality of upper plates; and
a second pressing member interposed between the plurality of lower plates,
wherein a magnetic force is generated at the first pressing member and the second pressing member by an applied current.

2. The battery cell pressing device according to claim 1, wherein the upper plate comprises a first upper plate in contact with an upper portion of the battery cell and a second upper plate spaced apart from the first upper plate in parallel.

3. The battery cell pressing device according to claim 2, wherein the first pressing member is interposed between the first upper plate and the second upper plate.

4. The battery cell pressing device according to claim 1, wherein the lower plate comprises a first lower plate in contact with a lower portion of the battery cell and a second lower plate spaced apart from the first lower plate in parallel.

5. The battery cell pressing device according to claim 4, wherein the second pressing member is interposed between the first lower plate and the second lower plate.

6. The battery cell pressing device according to claim 1, wherein each of the plurality of upper plates and the plurality of lower plates are spaced apart in parallel.

7. The battery cell pressing device according to claim 1, wherein an attractive force is generated between the first pressing member and the second pressing member by the magnetic force.

8. The battery cell pressing device according to claim 7, wherein the battery cell is pressurized by the attractive force.

9. The battery cell pressing device according to claim 1, wherein the first pressing member and the second pressing member have a coil shape.

10. The battery cell pressing device according to claim 1, wherein the first pressing member and the second pressing member are plural.

11. The battery cell pressing device according to claim 10, wherein the plurality of first pressing members and the plurality of second pressing members are the same in number and are disposed at positions corresponding to each other.

12. The battery cell pressing device according to claim 10, wherein the current is applied such that a magnetic force is formed in the same direction at the plurality of first pressing members.

13. The battery cell pressing device according to claim 10, wherein the current is applied such that a magnetic force is formed in the same direction at the plurality of second pressing members.

14. The battery cell pressing device according to claim 1, wherein the magnetic force at the first pressing member and the second pressing member is controlled by intensity of the current.

15. The battery cell pressing device according to claim 1, wherein the pressing device further comprises a pressure sensor.

16. The battery cell pressing device according to claim 15, wherein the pressure sensor measures pressure according to swelling during charging and discharging of the battery cell.

17. The battery cell pressing device according to claim 15, wherein the pressing device comprises a base plate capable of transmitting pressure of the battery cell to the pressure sensor.

18. The battery cell pressing device according to claim 17, wherein the pressure sensor is interposed between the base plate and the lower plate.

19. The battery cell pressing device according to claim 18, wherein the pressing device comprises a fastening means penetrating the plurality of upper plates, the plurality of lower plates, and the first pressing member and the second pressing member.

20. The battery cell pressing device according to claim 19, wherein the fastening means comprises a stopper member limiting separation of the upper plate.
